(19) United States
(12) Patent Application Publication
(10) Pub. No.: US 2010/0035201 A1
(43) Pub. Date: Feb. 11, 2010

(54) Universal Template Enabling Drilling and Placing a Dental Implant Into A Patient's Jaw

(75) Inventors: Israel Beck, Ramle (IL); Shabtay Benyamin, Modi'in (IL)

Correspondence Address: The Law Office of Michael E. Kondoudis, 888 16th Street, N.W., Suite 800, Washington, DC, 20006, US

(73) Assignees: Israel BECK, Ramle (IL); Shabtay BENYAMIN, Modi'in (IL)

(21) Appl. No.: 12/538,206

(22) Filed: Aug. 10, 2009

Related U.S. Application Data
(60) Provisional application No. 61/087,707, filed on Aug. 10, 2008.

(51) Int. Cl. A61C 3/02

(52) U.S. Cl. 433/76

(57) ABSTRACT

An apparatus for drilling into a patient's jaw, the apparatus comprising: a gel template; a cylinder embedded in the gel template; and a support arranged to fixate the gel template and the therein embedded cylinder in respect to the jaw, wherein the gel template comprises a gel selected to harden responsive of electromagnetic radiation, wherein the cylinder is arranged to allow drilling into the jaw, and wherein the cylinder is positioned within the gel template such as to enable drilling into the jaw through the cylinder.

### CROSS REFERENCE TO RELATED APPLICATIONS

This application claims the benefit of U.S. Provisional Patent Application No. 61087707 filed on Aug. 10, 2008, which is incorporated herein by reference.

### BACKGROUND

1. Technical Field

The present invention generally relates to the field of dentistry, and more particularly, to dental implantation.

2. Discussion of Related Art

Drilling a patient's jaw to place a dental implant involves measuring the patient's jaw, then ordering a tailored surgical template model, usually from a remote manufacturer, planning the implantation upon the template model and finally drilling according to the model.

### BRIEF SUMMARY

Embodiments of the present invention provide an apparatus for drilling into a patient's jaw, the apparatus comprising: a gel template; a cylinder embedded in the gel template; and a support arranged to fixate the gel template and the therein embedded cylinder in respect to the jaw, wherein the gel template comprises a gel selected to harden responsive of electromagnetic radiation, wherein the cylinder is arranged to allow drilling into the jaw, and wherein the cylinder is positioned within the gel template such as to enable drilling into the jaw through the cylinder.

Accordingly, according to an aspect of the present invention, there is provided an apparatus, wherein the gel template comprises proximally a first gel portion and distally a second gel portion, wherein the cylinder is embedded in the distal second gel portion, and wherein the apparatus further comprises a plurality of cannulae embedded in the proximal first gel portion and arranged to enable insertion of a plurality of tacks for fixating the gel template upon the jaw.

Embodiments of the present invention provide a kit for drilling into a patient's jaw comprising: at least one gel template; a plurality of cylinders embeddable in the at least one gel template; each cylinder corresponding to predefined characteristics of the drilling; and a support arranged to fixate the gel template and the therein embedded cylinder in respect to the jaw, wherein the at least one gel template comprises a gel selected to harden responsive of electromagnetic radiation, wherein the cylinder is arranged to allow drilling into the jaw therethrough, wherein the cylinder is positioned within the at least one gel template such as to enable drilling into the jaw through the cylinder, and wherein a combination of the at least one gel template and one of the cylinders is selectable for application in relation to the predefined characteristics of the drilling.

Embodiments of the present invention provide a method of placing a dental implant into a patient's jaw at a predefined location and along a predefined implantation direction, the method comprising: positioning and shaping a gel template comprising a cylinder to fit upon a part of the jaw, such that the cylinder is positioned at the predefined location and is oriented in the predefined implantation direction, and such that the cylinder allows drilling into the jaw and placing the dental implant into the jaw therethrough; hardening the gel template by using electromagnetic radiation; and drilling into the jaw through the cylinder.

Accordingly, according to an aspect of the present invention, there is provided a method, wherein the gel template comprises proximally a first gel portion and distally a second gel portion comprising a cylinder, and wherein the positioning and shaping a gel template comprises: positioning and shaping the first gel portion comprising a plurality of cannulae to fit upon the part of the jaw; hardening the first gel portion; fixating the first gel portion upon the jaw by inserting a plurality of tacks through the cannulae; placing the second gel portion on the first gel portion; positioning and shaping the second gel portion, such that the cylinder is positioned at the predefined location and is oriented in the predefined implantation direction, and such that the cylinder allows drilling into the jaw and placing the dental implant into the jaw therethrough; and hardening the second gel.

These, additional, and/or other aspects and/or advantages of the present invention are: set forth in the detailed description which follows; possibly inferable from the detailed description; and/or learnable by practice of the present invention.

### BRIEF DESCRIPTION OF THE DRAWINGS

The present invention will be more readily understood from the detailed description of embodiments thereof made in conjunction with the accompanying drawings of which:

FIG. 1 is an illustration of an apparatus for drilling into a patient's jaw for and placing a dental implant into the jaw, according to some embodiments of the invention;

FIG. 2 is an illustration of a two part apparatus for drilling into a patient's jaw for and placing a dental implant into the jaw, according to some embodiments of the invention;

FIG. 3 is a flowchart of a part of method of placing a dental implant into a patient's jaw, according to some embodiments of the invention;

FIG. 4 is a flowchart of a method of placing a dental implant into a patient's jaw utilizing sensors, according to some embodiments of the invention;

FIGS. 5A and 5B are illustrations of placing a two part apparatus into a patient's jaw, according to some embodiments of the invention;

FIGS. 6 is a high level schematic illustration of a kit for drilling into patient's jaw, and

FIGS. 7, 8A and 8B are schematic illustrations of an apparatus for drilling into patient's jaw, according to some embodiments of the invention; and

FIG. 9 is a high level schematic flowchart illustrating a method of placing a dental implant into a patient's jaw at a predefined location and along a predefined implantation direction, according to some embodiments of the invention.

### DETAILED DESCRIPTION

Before explaining at least one embodiment of the invention in detail, it is to be understood that the invention is not limited in its application to the details of construction and the arrangement of the components set forth in the following description or illustrated in the drawings. The invention is applicable to other embodiments or of being practiced or carried out in various ways. Also, it is to be understood that the phraseology and terminology employed herein is for the purpose of description and should not be regarded as limiting.

Embodiments of the present invention disclose an apparatus for and method of fitting a template to patients substantially immediately prior to an implantation treatment and adjusting the template to enable drilling into the jaw and placing the dental implant.

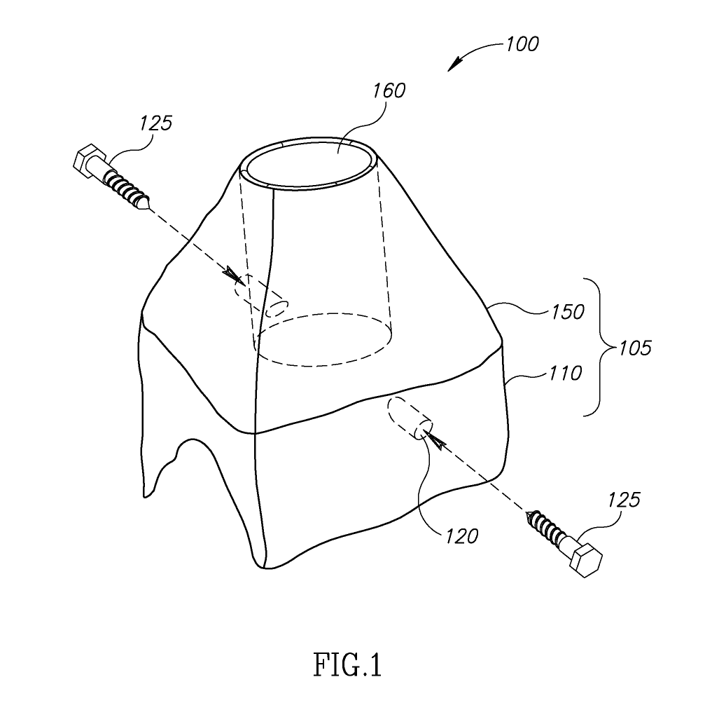

FIG. 1 is an illustration of a single part apparatus 100 for drilling into a patient's jaw for and placing a dental implant into the jaw, according to some embodiments of the invention. Single part apparatus 100 comprises a template 105 with a cylinder 160 and a plurality of cannulae 120 embedded in it. Template 105 comprises a proximal first gel portion 110 and a distal second gel portion 150. Cylinder 160 is embedded in distal second gel portion 150. Plurality of cannulae 120 are embedded in proximal first gel portion 110 and arranged to enable insertion of a plurality of tacks 125 for fixating template 105 upon the jaw.

According to some embodiments of the invention, first gel portion 110 and second gel portion 150 may be hardened in response to electromagnetic radiation. For example, gel portions 110 and 150 may be hardened by visible light, infrared light, ultraviolet light, laser radiation or by a combination of these. Gel portions 110 and 150 may be hardened responsive of electromagnetic radiation of different wavelength or intensity characteristics.

According to some embodiments of the invention, first gel portion 110 may be placed, fixated (made stationary) by tacks 125 and hardened to enable exact placing of cylinder 160 as a guiding element for drilling into a patient's jaw for and placing a dental implant into the jaw. Second gel portion 150 may be placed and hardened to fixate cylinder 160. Drilling into the jaw and placing the dental implant into the jaw may be carried out through cylinder 160.

According to some embodiments of the invention, single part apparatus 100 may be fitted to each patient substantially immediately prior to treatment and be adjusted to enable accurate drilling into the jaw and placing the dental implant. Single part apparatus 100 may thus be seen as a universal or generalized template. The dimensions of single part apparatus 100 may be customized in relation to the patient and available implants.

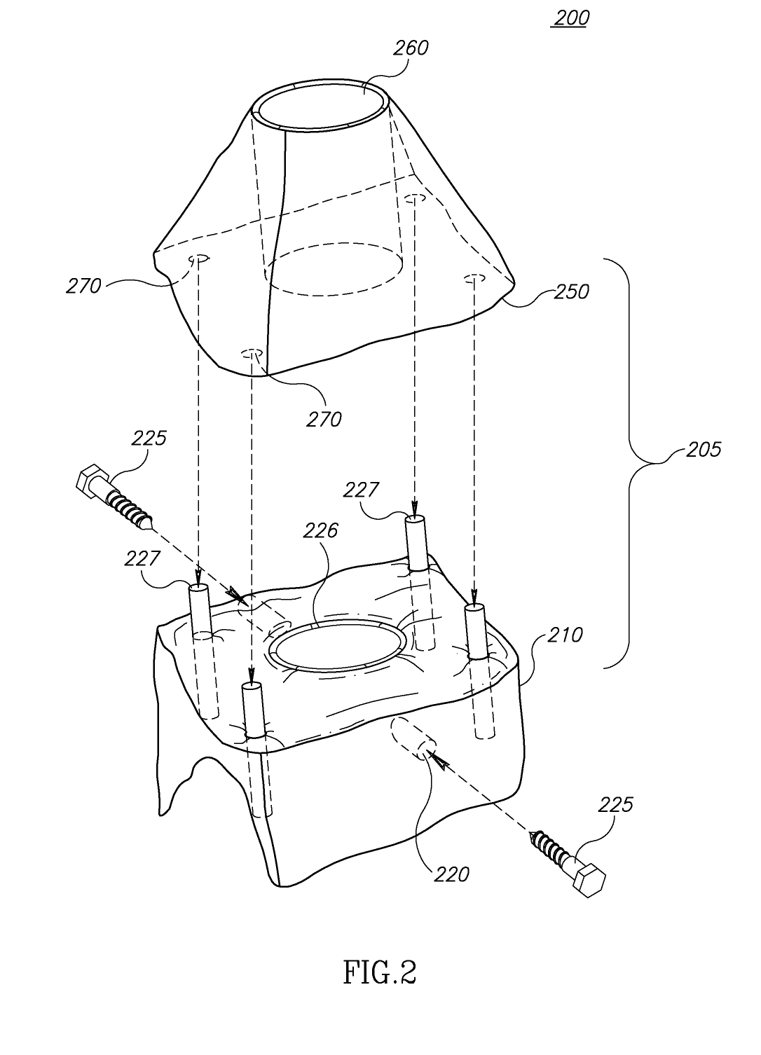

FIG. 2 is an illustration of a two part apparatus 200 for drilling into a patient's jaw for and placing a dental implant into the jaw, according to some embodiments of the invention. Two part apparatus 200 comprises a template 205 comprising a proximal first gel portion 210 and a distal second gel portion 250. A cylinder 260 is embedded in distal second gel portion 250. A plurality of cannulae 220 are embedded in proximal first gel portion 210 and arranged to enable insertion of a plurality of tacks 225 for fixating template 205 upon the jaw. Proximal first gel portion 210 and distal second gel portion 250 may be connected by a plurality of pins 227 attached to proximal first gel portion 210 and fitting into a plurality of sockets 270 in distal second gel portion 250.

According to some embodiments of the invention, first gel portion 210 and second gel portion 250 may be hardened responsive of electromagnetic radiation. For example, gel portions 210 and 250 may be hardened by visible light, infrared light, ultraviolet light, laser radiation or by a combination of these. Gel portions 210 and 250 may be hardened responsive of electromagnetic radiation of different wavelength or intensity characteristics.

According to some embodiments of the invention, two part apparatus 200 may be fitted to each patient substantially immediately prior to treatment and be adjusted to enable drilling into the jaw and placing the dental implant. Two part apparatus 200 may thus be seen as a universal or generalized template. The dimensions of two part apparatus 200 may be customized in relation to the patient and available implants.

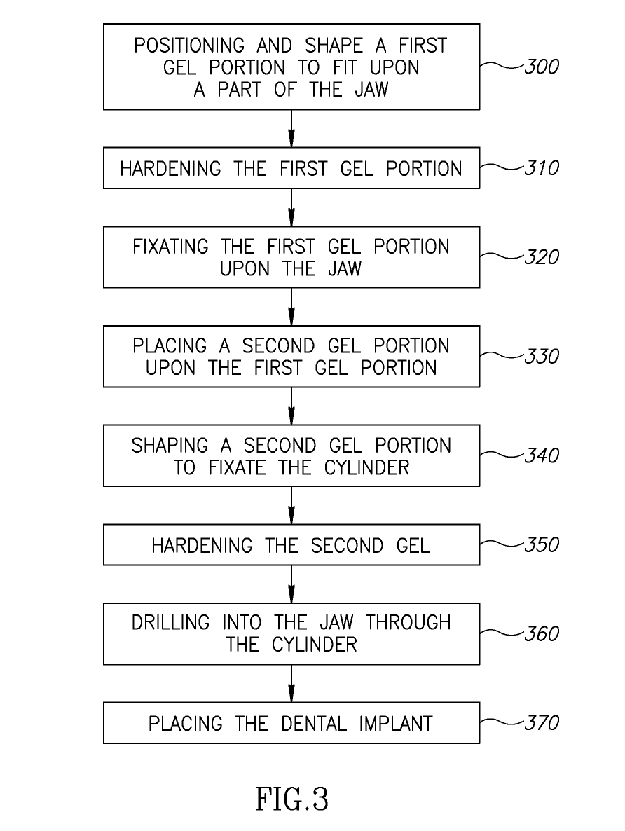

FIG. 3 is a flowchart of a part of a method of placing a dental implant into a patient's jaw, according to some embodiments of the invention. The method comprises the following stages. Positioning and shaping a first gel portion (stage 300) comprising a plurality of cannulae to fit upon a part of the jaw. The first gel portion may be fitted to each patient substantially immediately prior to treatment and be adjusted to enable drilling into the jaw and placing the dental implant. Further, hardening the first gel portion (stage 310) responsive of electromagnetic radiation. For example, the first gel portion may be hardened by visible light, infrared light, ultraviolet light, laser radiation or by a combination of these. Additional stages are: Fixating the first gel portion upon the jaw (stage 320) by inserting a plurality of tacks through the cannulae; placing a second gel portion upon the first gel portion (stage 330); positioning and shaping a second gel portion (stage 340), such that the cylinder corresponds to the direction of drilling and placing the dental implant. The cylinder may function as a guide for drilling and implantation. Further, hardening the second gel (stage 350) responsive of electromagnetic radiation. For example, the second gel portion may be hardened by visible light, infrared light, ultraviolet light, laser radiation or by a combination of these. The first and second gel portions may be hardened responsive of electromagnetic radiation of different wavelength or intensity characteristics. Additional stages are: drilling into the jaw through the cylinder (stage 360); and placing the dental implant (stage 370).

According to some embodiments of the invention, placing single part apparatus 100, two part apparatus 200 and accordingly the first and second gel portions as well as the cylinder (110, 150, 210, 250, 160, 260, stages 300, 330, 340) may be carried out utilizing any of: a position and angle sensor; a computerized navigation program based on a medical imaging method such as computer tomography (CT); magnetic resonance imaging (MRI); radiography; and ultrasonic methods, etc. More specifically, placing the apparatuses and executing the method may be carried out utilizing a computer program connected to an implant position and angle sensor (PAPS), a head angle and position sensor (HAPS), and a CT imaging device. PAPS and HAPS may be synchronized with the CT imaging device utilizing metal beads located on a flexible guided template. The computer program may produce a three dimensional image of the implantation area, identify the appropriate implant and implantation area and calculate the appropriate placing of either single part apparatus 100 or two part apparatus 200.

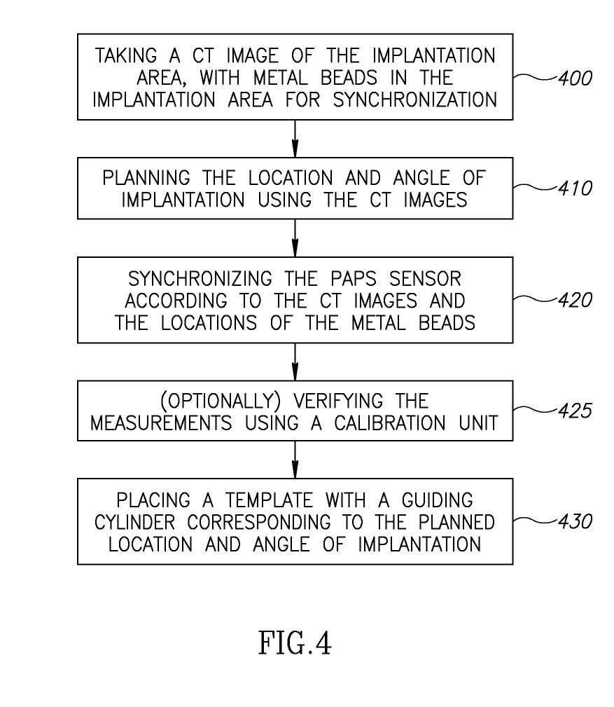

FIG. 4 is a flowchart of a method of placing a dental implant into a patient's jaw utilizing sensors, according to some embodiments of the invention. The method comprises the following stages: taking a CT image of the mouth, with a flexible guided template containing metal beads in the implantation area for synchronization (stage 400); planning the location and angle of implantation using the CT images (stage 410); synchronizing the PAPS sensor according to the CT images and the locations of the metal beads (stage 420); and placing a template with a guiding cylinder corresponding to the planned location and angle of implantation (stage 430) according to stages 300 to 370 and the sensor data.

The method may further comprise verifying the measurements using a calibration unit (stage 425), e.g., two metal beads connected by a metal thread of a gauged length, selected to allow verifying distance measurements on the CT image.

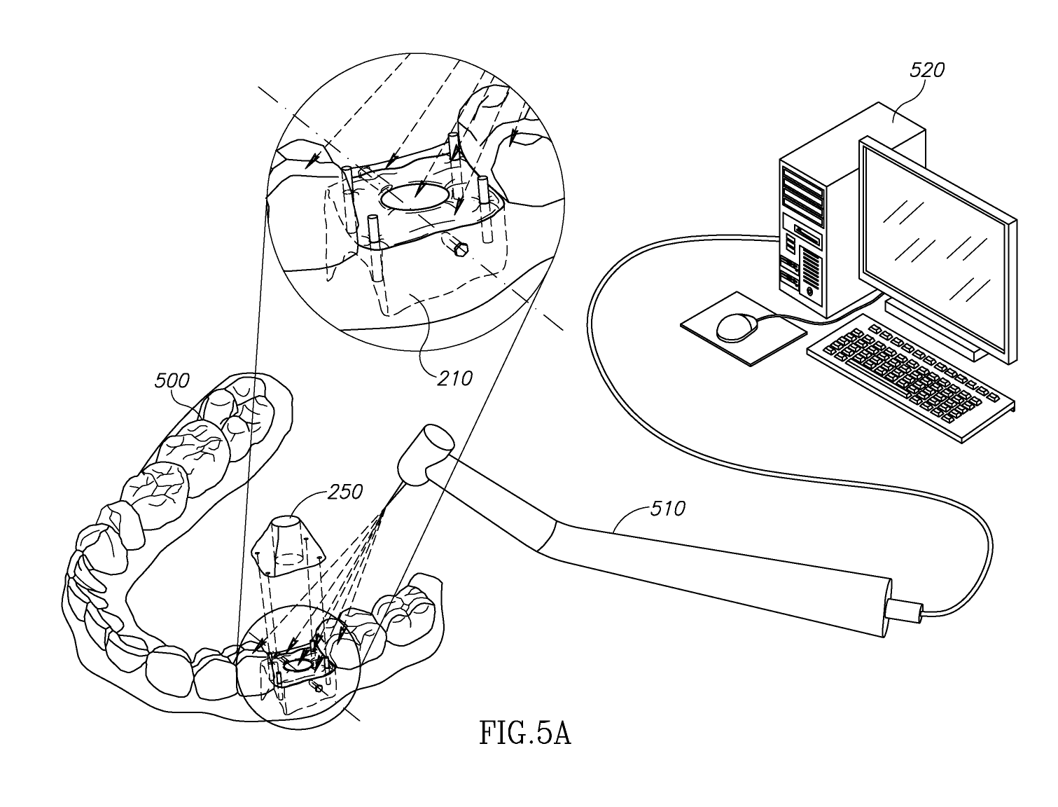

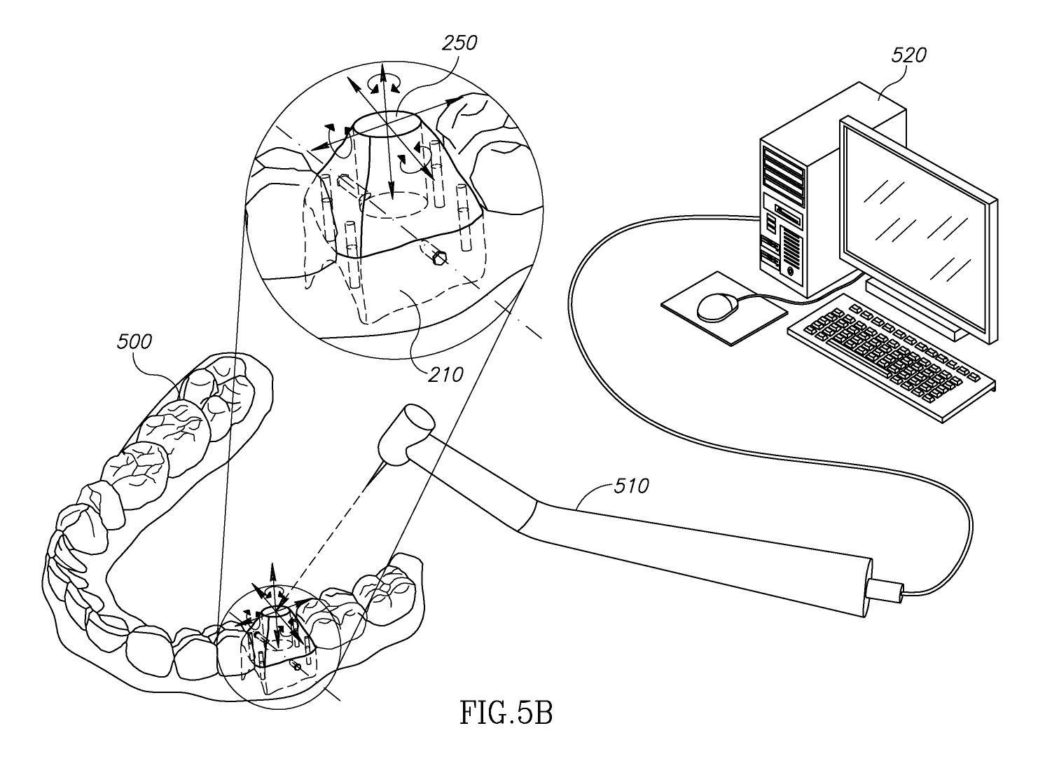

FIGS. 5A and 5B are illustrations of placing the two part apparatus 200 onto a patient's jaw 500, according to some embodiments of the invention. FIG. 5A illustrates placing a proximal first gel portion 210 onto patient's jaw 500 utilizing an implant position and angle sensor (PAPS) 510 connected to a computer 520 to position proximal first gel portion 210 in the correct 3 location. FIG. 5B illustrates placing a distal second gel portion 250 onto proximal first gel portion 210 in patient's jaw 500, utilizing an implant position and angle sensor (PAPS) 510 connected to a computer 520 to position distal second gel portion 250 in the correct 3 location.

One part apparatus 100 may be implanted using similar means and methods as illustrated in FIGS. 5A and 5B, likewise using positioning means, e.g., PAPS 510.

PAPS 510 allows a dentist to place apparatus 100 or 200 in either jaw in predefined position and a predefined angle to allow drilling into the jaw bone and inserting a dental implant through cylinder 160.

PAPS 510 is arranged to allow an exact location measurement in respect to a known reference point (e.g., in a precision of 1 mm and 1°). The exact location measurement may then be presented on computer 520, e.g., upon a CT (Computerized Tomography) image. PAPS 510 is arranged to allow the dentist to operate it in the clinic, with the patient sitting in the dentist's chair.

PAPS 510 may comprise a miniaturized distance and angle sensor (e.g., a triaxial accelerometer and a gyroscope, an Inertial Measurement Unit), a miniaturized inclinometer, and a miniaturized vibration sensor (e.g., an HAPS sensor) that may be connected to the jaw and measure jaw movements during the treatment. The miniaturized vibration sensor may be attached to the head, or to upper or lower jaws and measure position, angle and movements of jaw 500. PAPS 510 may be arranged to measure low accelerations and may be characterized by a low noise level and a time dependant measurement error. In operation, the measurement of the position and location of gel template 605 and/or cylinder 660 by PAPS 510 may be carried out during a short period, such that the measurement error is kept under a predefined threshold. For example, PAPS 510 may comprise miniaturized inertial sensors, that may be applied effectively due to the short measurement period that avoids a too large accumulation of measurement errors. Further, the measurement may be calibrated by metal beads or threads and anchor points or lines.

The miniaturized vibration sensor may communicate with computer 520 and/or PAPS 510 and its measurements may be automatically integrated in the positioning calculations. Alternatively, the measurements of the miniaturized vibration sensor may be used to alert the treating physician of head or jaw movements.

The flexible guided template may comprise a verification unit comprising, e.g., two metal beads connected by a metal thread of a gauged length to verify distance measurements on computer 520, e.g., on the CT image.

The systems and methods described above and below may be applied with necessary adaptations to either single part apparatus 100 or two part apparatus 200, or other embodiments thereof.

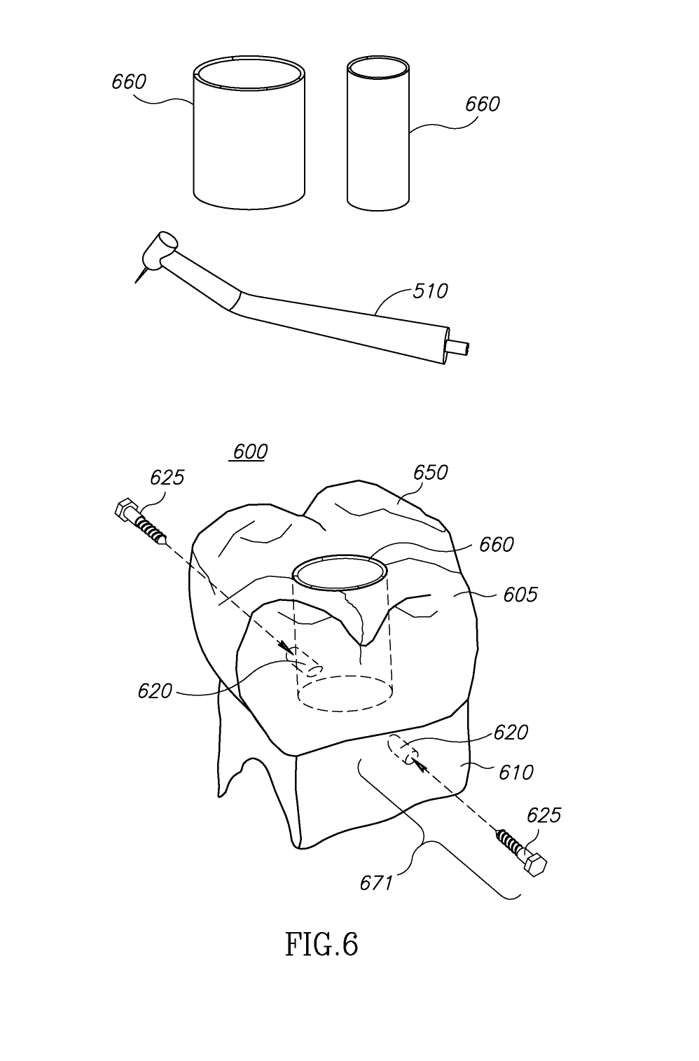

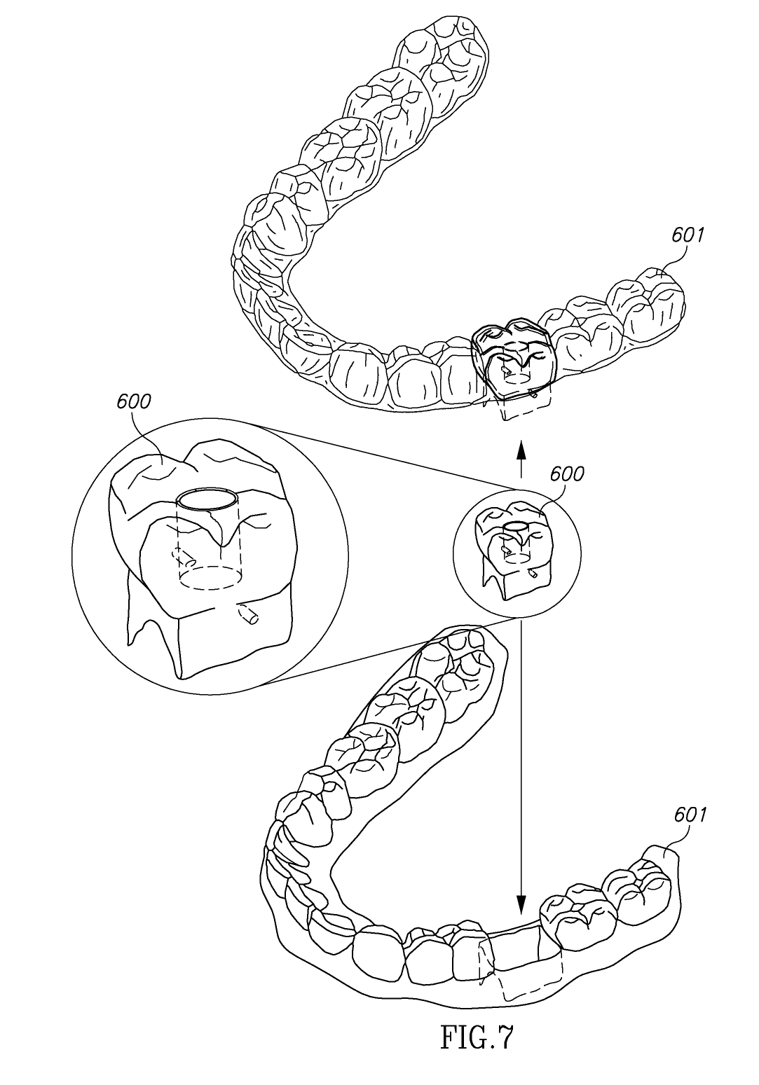

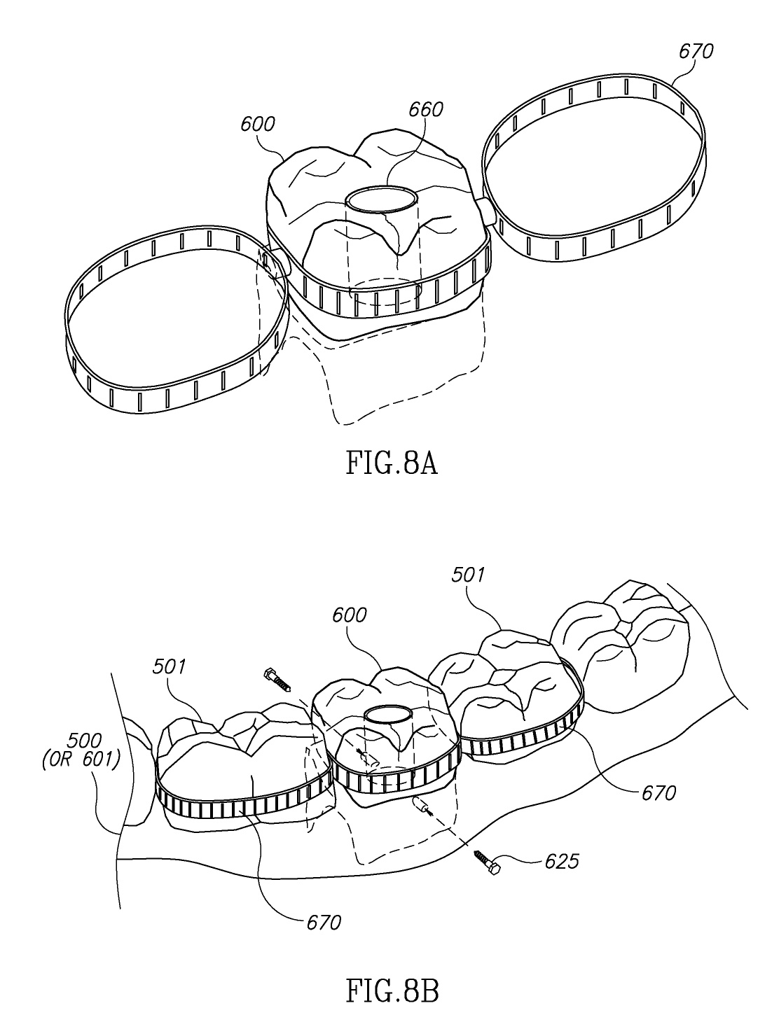

FIGS. 6 is a high level schematic illustration of a kit for drilling into patient's jaw 500, and FIGS. 7, 8A and 8B are schematic illustrations of an apparatus 600 for drilling into patient's jaw 500, according to some embodiments of the invention. Apparatus 600 may comprise a gel template 605; a cylinder 660 embedded in gel template 605; and a support 670 and/or 671 arranged to fixate gel template 605 and cylinder 660 embedded therein, in respect to jaw 500. Gel template 605 comprises a gel selected to harden responsive of electromagnetic radiation. Cylinder 660 is arranged to allow drilling into jaw 500 and optionally placing the dental implant into jaw 500 therethrough. Cylinder 660 is positioned within gel template 605 such as to enable drilling into jaw 500 and optionally placing the dental implant into jaw 500 through cylinder 660. Support 671 may comprise a plurality of cannulae 620 embedded proximally in gel template 605 and arranged to enable insertion of a plurality of tacks 625 for fixating gel template 605 upon jaw 500.

According to some embodiments of the invention, apparatus 600 may comprise apparatus 100 or apparatus 200. Apparatus 600 may be formed according to the form of a missing tooth and used as a temporary tooth. Cylinder 660 may be filled for that purpose. Apparatus 600 and/or frame 601 may incorporate metal beads used to calibrate positioning data on the CT image and calibration unit, e.g., two metal beads connected by a metal thread of a gauged length, selected to allow verifying distance measurements on the CT image.

Metal beads for calibration may be used on a separate template and removed after hardening the gel template.

According to some embodiments of the invention, support 670 may be arranged to be temporarily connected to adjacent teeth 501, to the gum in the vicinity of the application area, or to sensor 510 used to attach apparatus 600 to jaw 500. Apparatus 600 may further comprise a frame 601 arranged to be placed in proximity of gel template 605, (with or without support 670, or a support that is differently formed) or have a cavity for placing apparatus 600 within frame 601 as part thereof (see FIG. 7). Apparatus 600 may be connected to frame 601. Frame 601 may e.g., be a prosthesis. Frame 601 may be adaptable in its form to allow for predefined location and angles of cylinder 660 in respect to jaw 500. Apparatus 600 may be used to implant the dental implant from within its position in frame 601 or frame 601 may be used only to position apparatus 600 accurately. Support 670 may be connected to frame 601 or parts thereof, such as artificial teeth. Frame 601 may comprise, e.g., a temporary model of the teeth (made e.g., of rubber or plastic) that is placed upon the teeth in order to position apparatus 600 accurately.

According to some embodiments of the invention, gel template 605 comprises proximally a first gel portion 610 and distally a second gel portion 650, wherein cylinder 660 is embedded in distal second gel portion 650, and cannulae 620 are embedded in proximal first gel portion 610 and arranged to enable insertion of tacks 625 for fixating gel template 605 upon jaw 500.

According to some embodiments of the invention, apparatus 600 may further comprise navigation means (not shown) attachable to gel template 605 and allowing measurement of the position and location of cylinder 660. For example, navigation means may operate inertially and in communication with sensor 510 or computer 520. The navigation means may be arranged to measure low accelerations and may be characterized by a low noise level and a time dependant measurement error. In operation, the measurement of the position and location of gel template 605 and/or cylinder 660 by the navigation means may be carried out during a short period, such that the measurement error is kept under a predefined threshold. For example, the navigation means may comprise miniaturized inertial sensors, that may be applied effectively due to the short measurement period that avoids a too large accumulation of measurement errors. Further, the measurement may be calibrated by metal beads or threads and anchor points or lines.

According to some embodiments of the invention, FIG. 6 illustrates the kit for drilling into patient's jaw 500. The kit comprises: at least one gel template 605; a plurality of cylinders 660 embeddable in gel template 605; each cylinder 660 corresponding to predefined characteristics of the drilling (e.g., cylinders 660 having different diameters); and a support (e.g., 670 or 671) arranged to fixate gel template 605 and the therein embedded cylinder 660 in respect to jaw 500. Gel template 605 comprises a gel selected to harden responsive of electromagnetic radiation, cylinder 660 is arranged to allow drilling into jaw 500 therethrough, and cylinder 660 is positioned within gel template 605 such as to enable drilling into jaw 500 therethrough. Gel template 605 may already comprise cylinder 660 in the kit, or may formable upon application. For example, the kit may comprise a gel mass formable to gel template 605 upon application. Cylinder 660 may also be embedded into gel template 605 upon application or in advance. A combination of gel template 605 and one of cylinders 660 is selectable for application in relation to the predefined characteristics of the drilling. For example, different cylinders 660 may be fitted to varying drilling diameters, locations and techniques.

According to some embodiments of the invention, the kit may further comprise PAPS 510 arranged to allow positioning gel template 605 with cylinder 660 in a correct 3 location in respect to jaw 500 and to a planned implantation position. PAPS 510 may comprise a miniaturized distance sensor and a miniaturized inclinometer. PAPS 510 may be arranged to measure low accelerations and may be characterized by a low noise level and a time dependant measurement error. In operation, the measurement of the position and location of gel template 605 and/or cylinder 660 by PAPS 510 may be carried out during a short period, such that the measurement error is kept under a predefined threshold. For example, PAPS 510 may be applied effectively due to the short measurement period that avoids a too large accumulation of measurement errors. Further, the measurement may be calibrated by metal beads or threads and anchor points or lines.

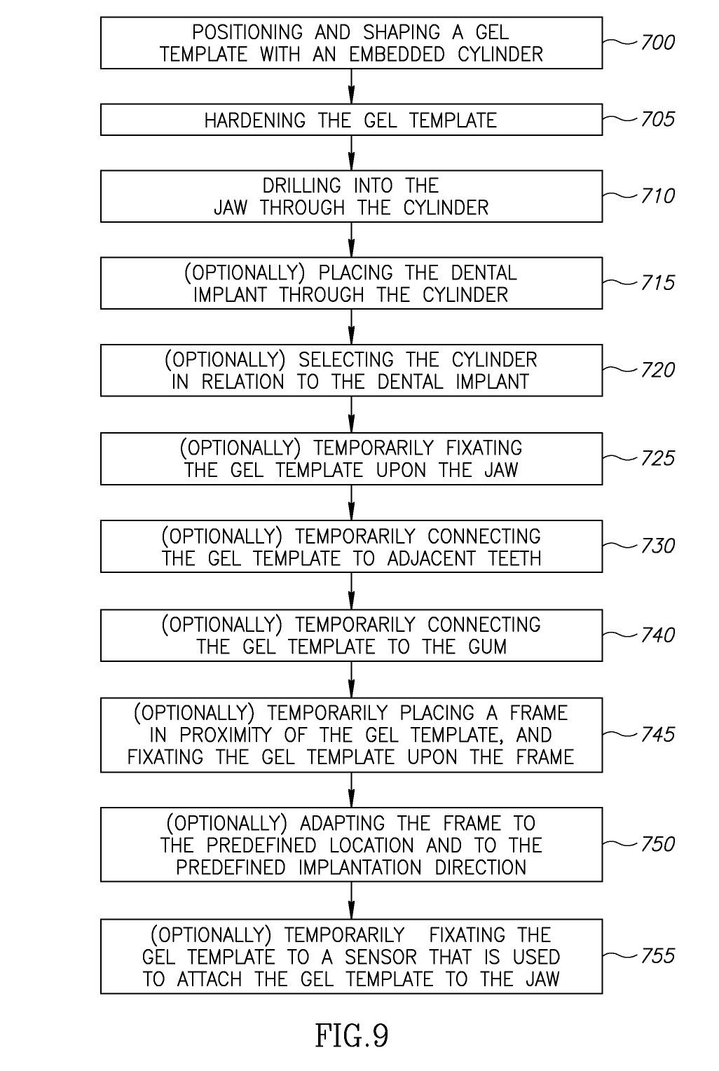

FIG. 9 is a high level schematic flowchart illustrating a method of placing a dental implant into a patient's jaw at a predefined location and along a predefined implantation direction, according to some embodiments of the invention. The method comprises the following stages: positioning and shaping a gel template comprising a cylinder to fit upon a part of the jaw (stage 700), such that the cylinder is positioned at the predefined location and is oriented in the predefined implantation direction, and such that the cylinder allows drilling into the jaw and placing the dental implant into the jaw therethrough; hardening the gel template by using electromagnetic radiation (stage 705); and drilling into the jaw through the cylinder (stage 710). According to some embodiments of the invention, the method may further comprise placing the dental implant through the cylinder (stage 715). According to some embodiments of the invention, the method may further comprise selecting the cylinder in relation to the dental implant (stage 720).

According to some embodiments of the invention, the gel template may comprise proximally a first gel portion and distally a second gel portion comprising a cylinder, and wherein the positioning and shaping a gel template comprises stages illustrated in FIGS. 3 and 4.

According to some embodiments of the invention, the method may further comprise temporarily fixating the gel template upon the jaw (stage 725) comprising, e.g., temporarily connecting the gel template to adjacent teeth (stage 730), or temporarily connecting the gel template to the gum (stage 740). Fixating the template may also be carried out by temporarily placing a frame in proximity of the gel template, and fixating the gel template upon the frame (stage 745). The method may further comprise adapting the frame to the predefined location and to the predefined implantation direction (stage 750). According to some embodiments of the invention, the method may further comprise temporarily fixating the gel template to a sensor that is used to attach the gel template to the jaw (stage 755). According to some embodiments of the invention, the method may further comprise temporarily fixating the gel template to a sensor used to place the gel template in the correct location and direction. According to some embodiments of the invention, the method may further comprise using navigation means to place the gel template correctly.

According to some embodiments of the invention, positioning the gel template (stage 700) may be carried out using an inertial sensor arranged to measure low accelerations and characterized by a low noise level and a time dependant measurement error, during a short period, such that the measurement error is kept under a predefined threshold.

In the above description, an embodiment is an example or implementation of the inventions. The various appearances of “one embodiment,” “an embodiment” or “some embodiments” do not necessarily all refer to the same embodiments.

Although various features of the invention may be described in the context of a single embodiment, the features may also be provided separately or in any suitable combination. Conversely, although the invention may be described herein in the context of separate embodiments for clarity, the invention may also be implemented in a single embodiment.

Reference in the specification to “some embodiments”, “an embodiment”, “one embodiment” or “other embodiments” means that a particular feature, structure, or characteristic described in connection with the embodiments is included in at least some embodiments, but not necessarily all embodiments, of the inventions.

It is to be understood that the phraseology and terminology employed herein is not to be construed as limiting and are for descriptive purpose only.

The principles and uses of the teachings of the present invention may be better understood with reference to the accompanying description, figures and examples.

It is to be understood that the details set forth herein do not construe a limitation to an application of the invention.

Furthermore, it is to be understood that the invention can be carried out or practiced in various ways and that the invention can be implemented in embodiments other than the ones outlined in the description above.

It is to be understood that the terms “including”, “comprising”, “consisting” and grammatical variants thereof do not preclude the addition of one or more components, features, steps, or integers or groups thereof and that the terms are to be construed as specifying components, features, steps or integers.

If the specification or claims refer to “an additional” element, that does not preclude there being more than one of the additional element.

It is to be understood that where the claims or specification refer to “a” or “an” element, such reference is not be construed that there is only one of that element.

It is to be understood that where the specification states that a component, feature, structure, or characteristic “may”, “might”, “can” or “could” be included, that particular component, feature, structure, or characteristic is not required to be included.

Where applicable, although state diagrams, flow diagrams or both may be used to describe embodiments, the invention is not limited to those diagrams or to the corresponding descriptions. For example, flow need not move through each illustrated box or state, or in exactly the same order as illustrated and described.

Methods of the present invention may be implemented by performing or completing manually, automatically, or a combination thereof, selected steps or tasks.

The term “method” may refer to manners, means, techniques and procedures for accomplishing a given task including, but not limited to, those manners, means, techniques and procedures either known to, or readily developed from known manners, means, techniques and procedures by practitioners of the art to which the invention belongs.

The descriptions, examples, methods and materials presented in the claims and the specification are not to be construed as limiting but rather as illustrative only.

Meanings of technical and scientific terms used herein are to be commonly understood as by one of ordinary skill in the art to which the invention belongs, unless otherwise defined.

The present invention may be implemented in the testing or practice with methods and materials equivalent or similar to those described herein.

Any publications, including patents, patent applications and articles, referenced or mentioned in this specification are herein incorporated in their entirety into the specification, to the same extent as if each individual publication was specifically and individually indicated to be incorporated herein. In addition, citation or identification of any reference in the description of some embodiments of the invention shall not be construed as an admission that such reference is available as prior art to the present invention.

While the invention has been described with respect to a limited number of embodiments, these should not be construed as limitations on the scope of the invention, but rather as exemplifications of some of the preferred embodiments. Other possible variations, modifications, and applications are also within the scope of the invention. Accordingly, the scope of the invention should not be limited by what has thus far been described, but by the appended claims and their legal equivalents.

What is claimed is:

1. An apparatus for drilling into a patient's jaw, the apparatus comprising:
a gel template;
a cylinder embedded in the gel template; and
a support arranged to fixate the gel template and the cylinder embedded therein to the jaw,
wherein the gel template comprises a gel that hardens in response to electromagnetic radiation,
wherein the cylinder is arranged to allow drilling into the jaw, and
wherein the cylinder is positioned within the gel template such as to enable drilling into the jaw through the cylinder.

2. The apparatus of claim 1, wherein the support comprises a plurality of cannulae embedded in the gel template and arranged to enable insertion of a plurality of tacks for fixating the gel template upon the jaw.

3. The apparatus of claim 1, wherein the support is temporarily connected to adjacent teeth.

4. The apparatus of claim 1, wherein the support is temporarily connected to a gum in the jaw.

5. The apparatus of claim 1, further comprising a frame arranged to be placed in proximity of the gel template, wherein the support is connected to the frame.

6. The apparatus of claim 5, wherein the frame is adaptable in its form to allow for predefined location and angles of the cylinder in respect to the jaw.

7. The apparatus of claim 1, wherein the support is temporarily connected to a sensor that is used to attach the apparatus to the jaw.

8. The apparatus of claim 1, wherein the gel template comprises a proximate first gel portion and a distal second gel portion, wherein the cylinder is embedded in the distal second gel portion, and wherein the apparatus further comprises a plurality of cannulae embedded in the proximal first gel portion and arranged to enable insertion of a plurality of tacks for fixating the gel template upon the jaw.

9. The apparatus of claim 1, further comprising navigation means attachable to the gel template for allowing measurement of the position and location of the cylinder.

10. A kit for drilling into a patient's jaw, comprising:
at least one gel template;
a plurality of cylinders, each embeddable in the at least one gel template and corresponding to predefined drilling characteristics; and
a support arranged to fixate the gel template and a one of the plurality of cylinders embedded therein to the jaw,
wherein the at least one gel template comprises a gel that hardens in response to electromagnetic radiation,
wherein the cylinder is arranged to allow drilling into the jaw therethrough,
wherein the embedded cylinder is positioned within the at least one gel template such as to enable drilling into the jaw through the cylinder, and
wherein a combination of the at least one gel template and one of the cylinders is selectable for application in relation to the predefined drilling characteristics.

11. The kit of claim 10, further comprising:
an implant position and angle sensor (PAPS) arranged to allow positioning the gel template with the cylinder in a correct 3 location in respect to the jaw and to a planned implantation position, the PAPS comprising a miniaturized distance sensor and a miniaturized inclinometer,
wherein the PAPS is arranged to measure low accelerations and is characterized by a low noise level and a time dependant measurement error, and
wherein operably positioning the gel template with the cylinder in a correct 3 location is carried out during a short period, such that the measurement error is kept under a predefined threshold.

12. A method of placing a dental implant into a patient's jaw at a predefined location and along a predefined implantation direction, the method comprising:
positioning and shaping a gel template comprising a cylinder to fit upon a part of the jaw, such that the cylinder is positioned at the predefined location and is oriented in the predefined implantation direction, and such that the cylinder allows drilling into the jaw and placing the dental implant into the jaw therethrough;
hardening the gel template by electromagnetic radiation; and
drilling into the jaw through the cylinder.

13. The method of claim 12, further comprising placing the dental implant through the cylinder

14. The method of claim 12, wherein the gel template comprises a proximate first gel portion and a distal second gel portion comprising a cylinder, and wherein the positioning and shaping a gel template comprises:
positioning and shaping the first gel portion comprising a plurality of cannulae to fit upon the part of the jaw;
hardening the first gel portion;
fixating the first gel portion upon the jaw by inserting a plurality of tacks through the cannulae;
placing the second gel portion on the first gel portion;
positioning and shaping the second gel portion, such that the cylinder is positioned at the predefined location and is oriented in the predefined implantation direction, and such that the cylinder allows drilling into the jaw and placing the dental implant into the jaw therethrough; and
hardening the second gel.

15. The method of claim 12, further comprising selecting the cylinder in relation to the dental implant.

16. The method of claim 12, further comprising temporarily fixating the gel template upon the jaw.

17. The method of claim 16, wherein the temporarily fixating the gel template upon the jaw comprises temporarily connecting the gel template to adjacent teeth.

18. The method of claim 16, wherein the temporarily fixating the gel template upon the jaw comprises temporarily connecting the gel template to the gum.

19. The method of claim 12, further comprising temporarily placing a frame in proximity of the gel template, and fixating the gel template upon the frame.

20. The method of claim 19, further comprising adapting the frame to the predefined location and to the predefined implantation direction.

21. The method of claim 12, further comprising temporarily fixating the gel template to a sensor that is used to attach the gel template to the jaw.

22. The method of claim 12, further comprising verifying the measurements using a calibration unit.

23. The method of claim 12, wherein the positioning the gel template is carried out using an inertial sensor arranged to measure low accelerations and characterized by a low noise level and a time dependant measurement error, during a short period, such that the measurement error is kept under a predefined threshold.

24. A system for implanting a dental implant into a patient's jaw, comprising:
an apparatus for drilling into a patient's jaw, comprising:
a gel template;
a cylinder embedded in the gel template; and
a support arranged to fixate the gel template and the cylinder embedded therein to the jaw, and
an implant position and angle sensor (PAPS) connected to a computer and arranged to allow position the apparatus in a correct 3 location in respect to the jaw and to a planned implantation position,
wherein the gel template comprises a gel that hardens in response to electromagnetic radiation,
wherein the cylinder is arranged to allow drilling into the jaw and implanting the dental implant therethrough, and
wherein the cylinder is positioned within the gel template such as to enable drilling into the jaw through the cylinder.

25. The system of claim 24, wherein data from the PAPS is presented upon a CT image on the computer, so as to enable positioning the apparatus.

26. The system of claim 25, further comprising a verification unit comprising at least one metal beads, arranged to allow calibrating apparatus location upon the CT image.

27. The system of claim 24, wherein the PAPS comprises a miniaturized distance sensor, a miniaturized inclinometer and a miniaturized vibration sensor connected to the jaw and arranged to measure jaw movements during implantation.

28. The system of claim 24, wherein the PAPS is arranged to measure low accelerations and is characterized by a low noise level and a time dependant measurement error, and wherein operably positioning the apparatus is carried out during a short period, such that the measurement error is kept under a predefined threshold.
